(19) United States
(12) Patent Application Publication
(10) Pub. No.: US 2002/0141699 A1
(43) Pub. Date: Oct. 3, 2002

(54) Optical fiber bragg grating thermal compensating device and method for manufacturing same

(75) Inventors: Yu-Lung Lo, Young-Kang City (TW); John Lin, Taipei (TW); Chih-Ping Kuo, Kaohsiung (TW)

Correspondence Address: Ladas & Parry, 26 West 61st Street, New York, NY, 10023, US

(73) Assignee: BROPTICS COMMUNICATION CORPORATION

(21) Appl. No.: 09/843,398

(22) Filed: Apr. 26, 2001

(30) Foreign Application Priority Data
Feb. 13, 2001 (TW) 90103140

(51) Int. Cl. G02B 6/34

(52) U.S. Cl. 385/37; 385/99; 385/137

(57) ABSTRACT

This invention discloses a plurality of compensating devices for correcting temperature deviation of optical fiber Bragg grating (FBG). These devices includes means for compressing optical fibers being affixed to a substrate, and fiber grids being cured to the substrate and/or the compressing means under a thermal state, or fiber grids being affixed to the substrate and/or the compressing means while the fiber grids are under tension. This invention further discloses methods for manufacturing such devices. The FBG thermal compensating devices according to this invention consist the advantages of simple constructions and simplified manufacturing processes. One of the devices can resolve the heat-dissipating problem so as to allow immediate thermal expansion of the fiber grids. Another device allows rapid positioning and manufacturing. One of the devices allows the fiber grids to be directly secured to a thermal compensating substrate without needing additional pre-processes.

During the manufacturing processes, AB thermally cured adhesive can be implemented to affix the fiber grids to the device under a thermal state so as to eliminate the implementation of pre-loading. The device can also be placed under a thermal state, after the process of thermal curing, for a pre-determined period of time so as to perform annealing to the fiber grids thereby further simplifying the manufacturing process.

### FIELD OF INVENTION

This invention is related to optical communication passive element packages and manufacturing methods thereof, in particular to a plurality of optical fiber Bragg grating thermal compensating devices and methods for manufacturing same.

### BACKGROUND OF INVENTION

Optical Fiber Bragg grating (FBG) are commonly implemented in various components for manufacturing of dense wavelength division multiplexing (DWDM), such as FBG stabilizing laser source, and various DWDM devices used in multiplexer, de-multiplexer, and optical add-drop multiplexer (OADM). However, in actual implementation, increment of environmental temperature may affect the performance of the FBG. Because the grid pitch and index of refraction of the FBG determine the central frequency of the reflected light, special care must be given to ensure the precision of the FBG. Since increment of environmental temperature will change the index of refraction of the FBG causing increment of the wavelength of the optical fiber thereby deviating from the designated central wavelength, measures shall be taken to prevent occurrences of such changes.

FIG. 9 illustrates a conventional FBG thermal compensating device using a bi-metal construction, where the device comprises two arms 13, 13′ and two metal sheets 14, 15. The two metal sheets 14, 15 are soldered to one another and the two arms 13, 13′ are soldered to the opposing sides of the metal sheets 14, 15, wherein one of the metal sheets has a thermal expansion coefficient that is smaller than the thermal expansion coefficient of another metal sheet.

Though such a thermal compensating device can reduce thermal effects to the optical fiber, the tolerances accumulated during the manufacturing and packaging processes prevent the compensating value of such a device from reaching the desired precision.

FIG. 10 illustrates another conventional FBG thermal compensating device using a bi-metal construction, where the device comprises two metal blocks 21, 22 of complimentary configurations, wherein one of the metal blocks has a thermal expansion coefficient that is smaller than the thermal expansion coefficient of another metal block. FBG 17 is affixed between the two metal blocks. The two metal blocks 21, 22 are affixed to one another through pre-loaded bolts 30 so as to reduce thermal effects to the FBG 17.

Though such a thermal compensating device can reduce thermal effects to the optical fiber, its complicated construction and the need of an additional pre-loading process cause difficulty in manufacturing and increase manufacturing cost.

### SUMMARY OF INVENTION

It is, thus, an object of this invention to resolve the above problems by providing a plurality of compensating devices for correcting temperature deviation of fiber grids and methods for manufacturing the same. These devices include means for compressing the fiber grids while the optical fiber experiences an increment in temperature.

In one embodiment, the compressing means includes at least one metal block or thin film being affixed or suspended to a substrate, and fiber grids being cured to the substrate and/or the metal block under a thermal state, or fiber grids being affixed to the substrate and/or the metal block while the fiber grids are under tension.

This invention further discloses methods for manufacturing such devices.

The FBG thermal compensating devices according to this invention consist the advantages of simple constructions and simplified manufacturing processes.

One of the devices can resolve the heat-dissipating problem so as to allow immediate response of the metal block to the thermal expansion of the fiber grids. Another device allows rapid positioning and manufacturing. One of the devices allows the fiber grids to be directly secured to a thermal compensating substrate without needing additional pre-processes. During the manufacturing processes, AB thermally cured adhesive can be implemented to affix the fiber grids to the device under a thermal state so as to eliminate the implementation of pre-loading. The device can also be placed under a thermal state, after the process of thermal curing, for a pre-determined period of time so as to perform annealing to the fiber grids thereby further simplifying the manufacturing process.

Other aspects and advantages of the present invention are listed in the following detailed description accompanied by the drawings, which also illustrates by way of examples the principles of the invention.

### BRIEF DESCRIPTION OF DRAWINGS

FIG. 1 is a top plan view illustrating a first embodiment of an FBG thermal compensating device according to this invention;

FIG. 1A is a schematic plan view illustrating the first embodiment of FIG. 1 further including a manually adjusting means;

FIG. 2 is a top plan view illustrating a second embodiment of an FBG thermal compensating device according to this invention;

FIG. 2A is a schematic view illustrating the second embodiment of FIG. 2 further including a manually adjusting means;

FIG. 3 is a top plan view illustrating a third embodiment of an FBG thermal compensating device according to this invention;

FIG. 3A is a schematic view illustrating the third embodiment of FIG. 3 further including a manually adjusting means;

FIG. 4A is a flowchart illustrating the method for manufacturing the FBG thermal compensating device of FIG. 1;

FIG. 4B is a flowchart illustrating an alternative method for manufacturing the FBG thermal compensating device of FIG. 1;

FIG. 4C is a flowchart illustrating the method for manufacturing the FBG thermal compensating device of FIG. 2;

FIG. 4D is a flowchart illustrating an alternative method for manufacturing the FBG thermal compensating device of FIG. 2;

FIG. 4E is a flowchart illustrating an alternative method for manufacturing the FBG thermal compensating device of FIG. 3;

FIG. 5 is a comparison chart illustrating the compensation result of the first embodiment;

FIG. 6 is a top plan view illustrating a fourth embodiment of an FBG thermal compensating device according to this invention;

FIG. 6A is a schematic view illustrating the fourth embodiment of FIG. 6 further including a manually adjusting means;

FIG. 7 is a top plan view illustrating a fifth embodiment of an FBG thermal compensating device according to this invention;

FIG. 7A is a schematic view illustrating the fifth embodiment of FIG. 7 further including a manually adjusting means;

FIG. 8A is a flowchart illustrating a method for manufacturing the FBG thermal compensating device of FIG. 6;

FIG. 8B is a flowchart illustrating another method for manufacturing the FBG thermal compensating device of FIG. 6;

FIG. 8C is a flowchart illustrating a method for manufacturing the FBG thermal compensating device of FIG. 7;

FIG. 8D is a flowchart illustrating another method for manufacturing the FBG thermal compensating device of FIG. 7;

FIG. 9 illustrates a conventional FBG thermal compensating device using a bi-metal construction; and

FIG. 10 illustrates another conventional FBG thermal compensating device using a bi-metal construction.

### LIST OF REFERENCE NUMERALS

10, 10′, 10″, 6, 7 compensating device

12, 12′, 12″, 62, 72 substrate

14, 14′, 14″ first metal block

16, 16′, 16″, 66, 76 optical fiber

18, 18′, 18″, 68, 78 fiber Bragg grid

19″ compensating block

20, 20′, 20″, 60, 70 manually adjusting means

22, 22′, 22″ second indent

24, 24′, 24″ threaded rod

26, 26′, 26″ positive screw thread

28, 28′, 28″ counter screw thread

122, 122′, 122″, 622, 722 first indent

124, 124′ space

142′ second metal block

162, 162′, 163, 163′, 164 affixing points

221, 221′, 221″ first arm

222, 222′, 222″ second arm

64 metal thin film

74 floating metal block

75 elastically deformable adhesive

662, 663, 762, 763 affixing points

741, 742 affixing pointsL1 first length

L2 second length

L3 third length

L4 fourth length

L5 fifth length

L6 sixth length

LG overall length of grid

### DETAILED DESCRIPTIONS OF EMBODIMENTS

First Embodiment

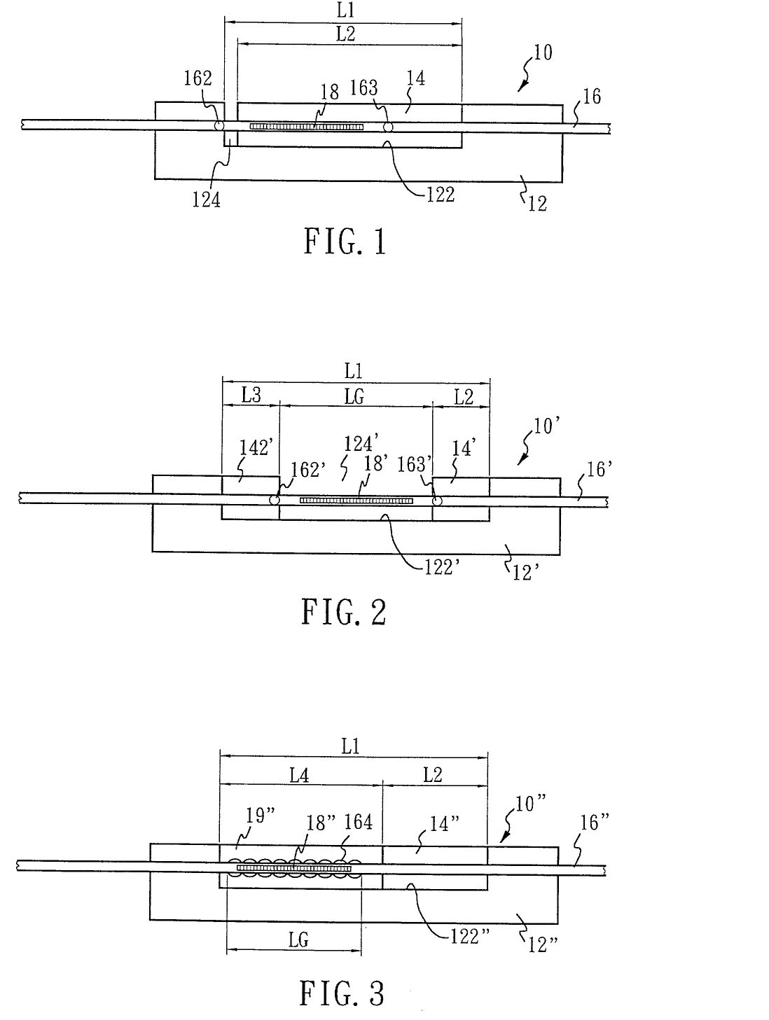

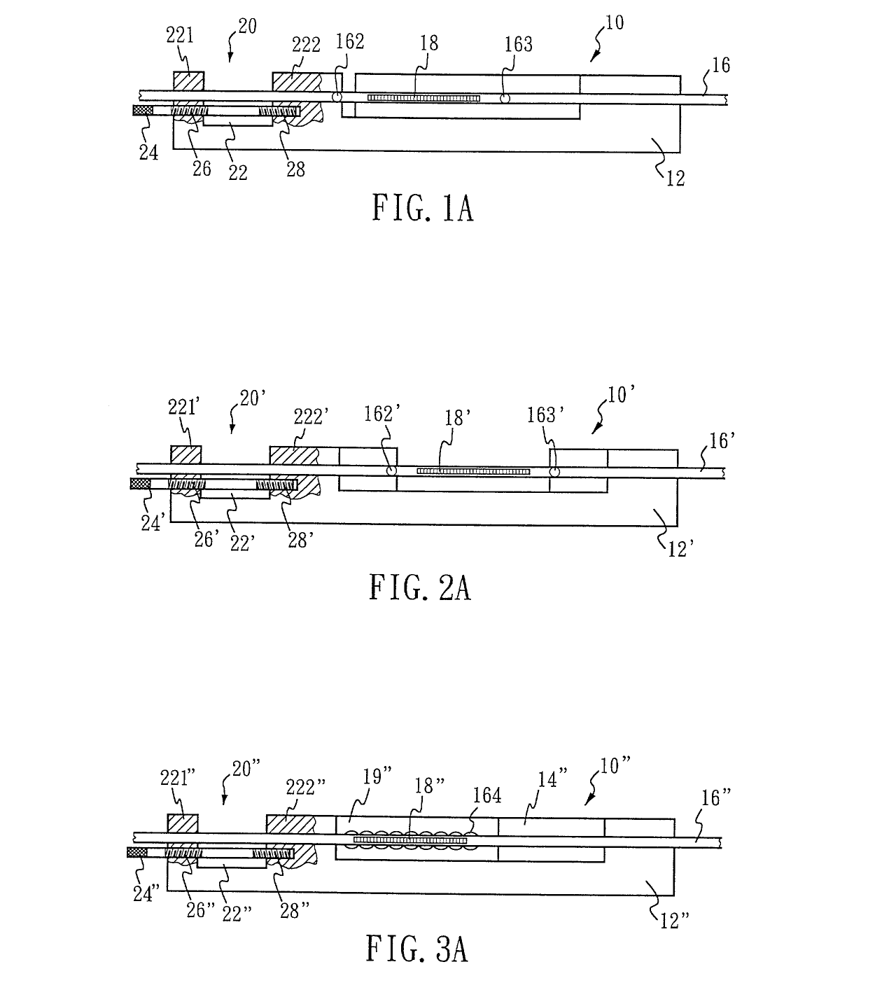

FIG. 1 is a top plan view illustrating a first embodiment of an FBG thermal compensating device 10 according to this invention. The device 10 comprises: a substrate 12, means for compressing optical fiber, and an optical fiber 16. In this embodiment, the compressing means includes a metal block 14 affixed to the substrate 12, and the optical fiber 16 is affixed to the substrate 12 and the metal block 14 along a longitudinal direction thereof, wherein the optical fiber 16 is embedded with grids 18 at a mid-section thereof.

As illustrated in FIG. 1, the substrate 12 is formed with a first indent 122 thereon. The first indent 122 has a first length L1 that is greater than a second length L2 of the metal block 14 such that when the metal block 14 is affixed into the first indent 122, the substrate 12 is remained with a space 124.

The substrate 12 is preferably made of quartz; the metal block 14 is preferably made of aluminum or stainless steel. In this embodiment, the optical fiber 16 has an end that is affixed to the substrate 12 at a first affixing point 162, and another end to the metal block 14 at a second affixing point 163 in such a manner that the grids 18 of the optical fiber 16 overlap the metal block 14 and located between the two affixing points 162, 163.

The fiber grids 18 are preferably to be affixed to the substrate and/or metal block by means of instant cured adhesive while the fiber grids 18 are under tension. The optical fiber 16 may alternatively be first adhered to the substrate 12 and the metal block 14 using AB thermally cured adhesive, and then cured to the substrate 12 and the metal block 14 under a thermal state—such as at a temperature of 100° C. The device may further be placed under a thermal state, after the process of thermal curing, for a pre-determined period of time so as to perform annealing to the fiber grids 18 thereby further simplifying the manufacturing process.

When the device experiences thermal effects, such as increment in environmental temperature, the entire device 10 will expand. Because the quartz substrate 12 has a thermal expansion coefficient that is much smaller than the thermal expansion coefficient of the metal block 14, the expansion effect of the quartz substrate 12 can, thus, be neglected.

Under such a state, only the metal block 14, in relation to the entire device 10, expands towards the space 124 thereby compressing the fiber grids 18 located between the two affixing points 162, 163, and causing reduction of the grid wavelength that was increased as a result of increment in environmental temperature. As such, the central wavelength of the fiber grids 18 can be prevented from deviation. The affixing points 162, 163 of the device 10 can be determined by referring to the followings:

Assuming that the fiber grid 18 is not adhered to the metal block 14 while experiencing the aforementioned thermal effects, the effects that the fiber grids 18 experience under such a state may be represented by:

$$\frac{Δ {λ}_{B}}{{λ}_{B}} ≅ ξ Δ T ( Free )$$

wherein,

λ_{B}: central wavelength of the FGB

Δλ_{B}: amount of central wavelength deviation of the fiber grids

ξ: Thermal-Optic Coefficient of the optical fiber

ΔT: change in temperature

On the other hand, if the fiber grids 18 are adhered to the metal block 14 that provides that thermal compensating effects, a negative strain is applied to the fiber grids 18 resulting in change of strain value, such a state may be represented by:

$$\frac{Δ {λ}_{B}}{{λ}_{B}} = ( 1 - Pe ) {ϵ}_{x} ( Axial \text{-} Strain )$$

wherein,

εx: axial strain applied to the fiber grids

(1-Pe): strain-Optic Coefficient of the optical fiber

In order to achieve the intended compensating effects, it is required that:

$$\frac{Δ {λ}_{B}}{{λ}_{B}} ( Free ) + \frac{Δ {λ}_{B}}{{λ}_{B}} ( Axial \text{-} Strain ) = 0$$

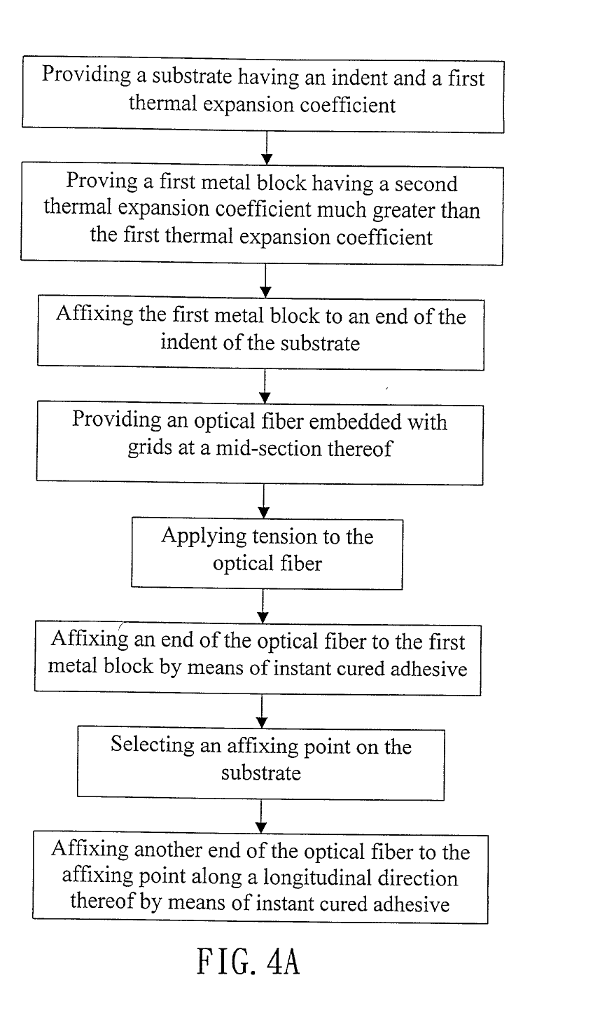

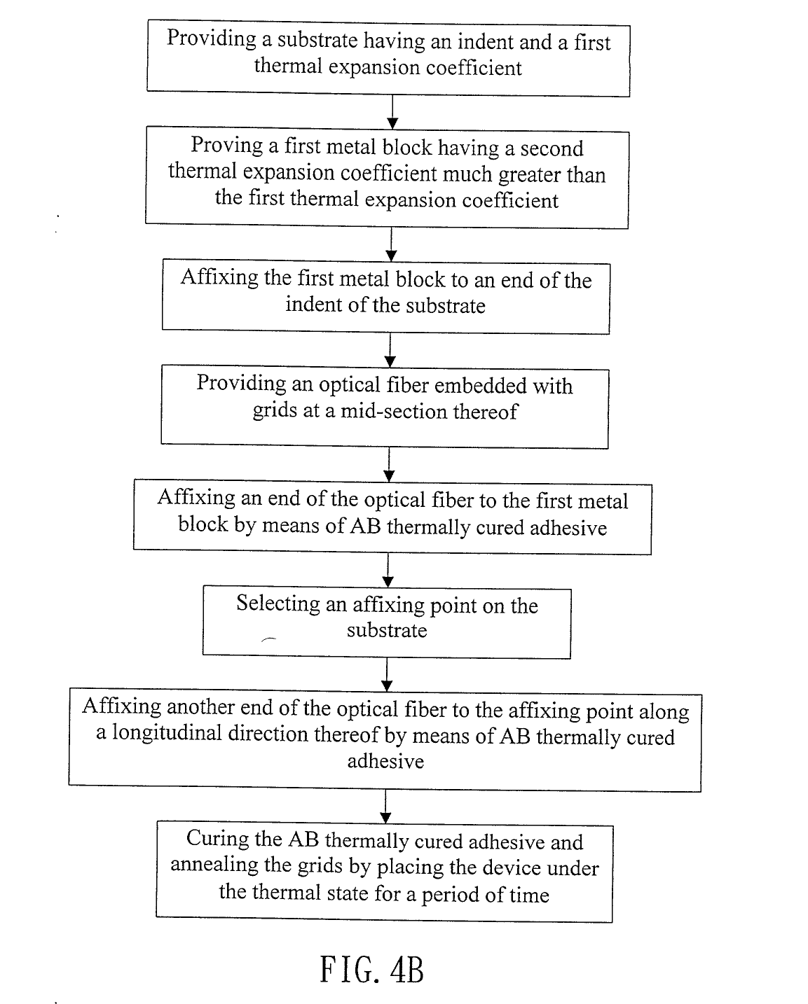

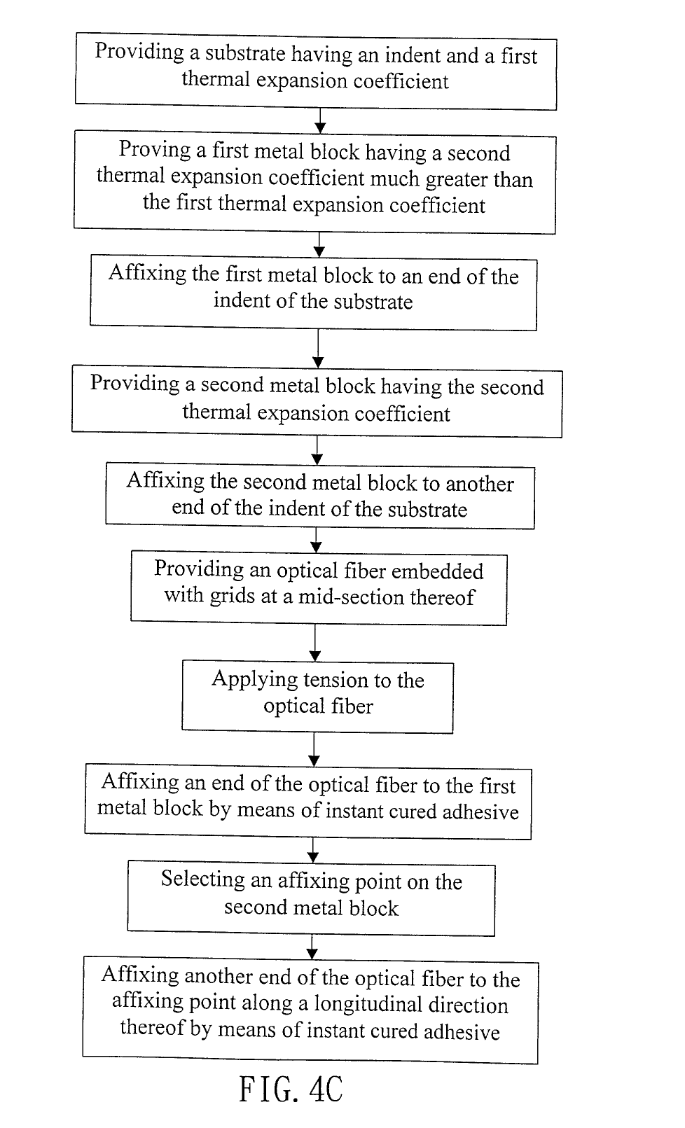

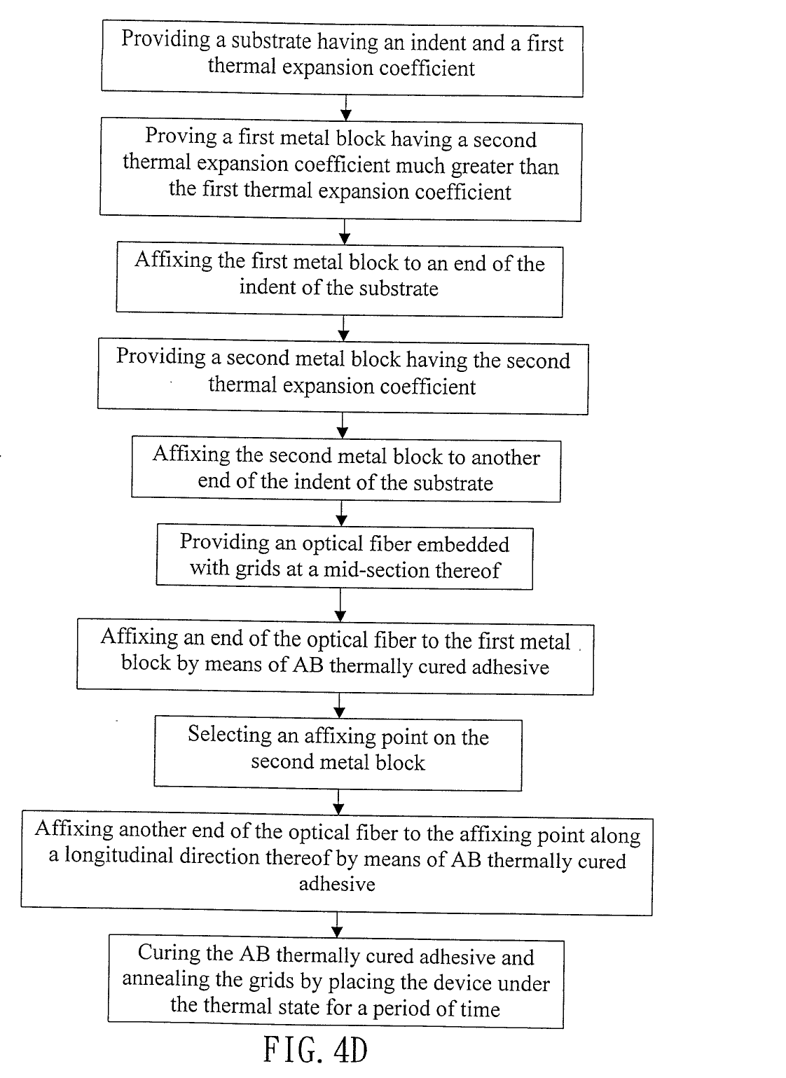

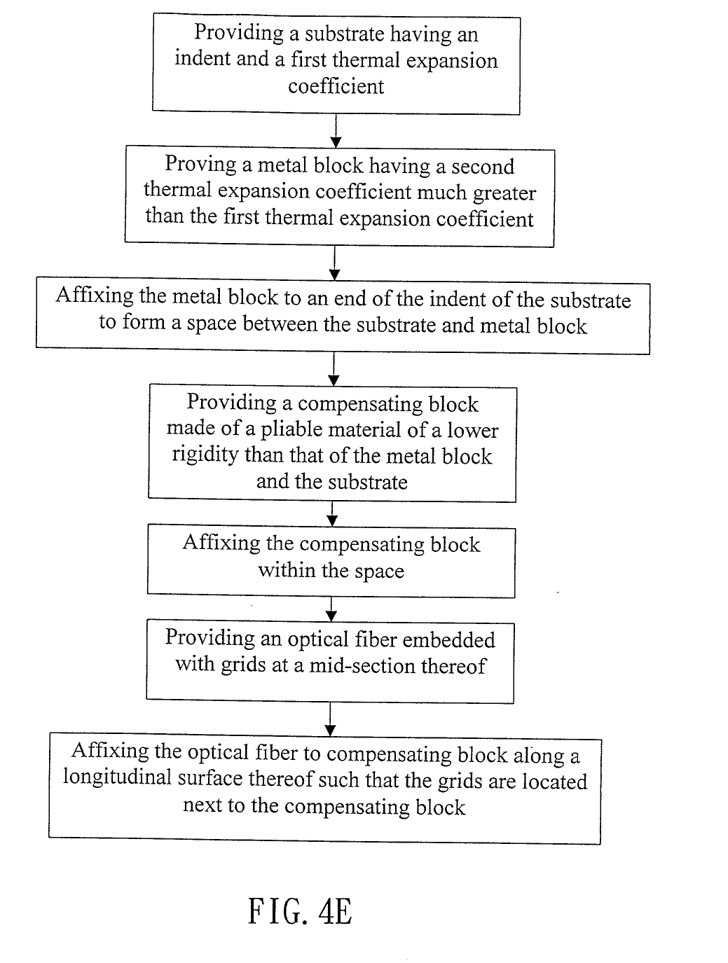

FIGS. 4A and 4B illustrate two flowcharts for manufacturing the optical fiber Bragg grating thermal compensating device of FIG. 1. In the devices named in FIGS. 4A and 4B, prior to affixing an end of the optical fiber 16 to the affixing point 162, the affixing point 163 is selected on the metal block 14 in accordance with the above equation.

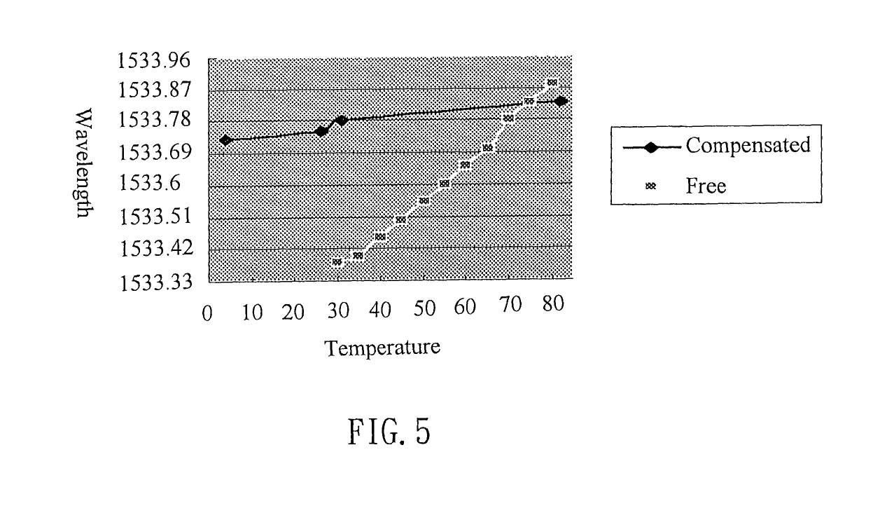

The compensating effects of the first embodiment are as depicted in FIG. 5. The data being referred to as (Free) in FIG. 5 shows the change of wavelength while the device of this invention is not implemented; the data being referred to as (Compensated) in FIG. 5 shows that change of wavelength while the device of this invention is implemented. It is, thus, known from FIG. 5 that, as compared with fiber grids that are not equipped with the compensating device of this invention, the thermal effects that the fiber grids experiences can be significantly reduced.

Referring to FIG. 1A, the FBG thermal compensating device 10 of the first embodiment illustrated in FIG. 1 may further include a manually adjusting means 20 coaxially provided on the substrate 12 along the longitudinal direction of the substrate 12. In the embodiment illustrated in FIG. 1A, the substrate 12 is further formed with a second indent 22 at one end of the substrate 12, and forming two arms 221 and 222 spaced apart along the longitudinal direction of the substrate 12. A threaded rod 24 having a section of positive screw thread 26 and a section of counter screw thread 28 is disposed across the second indent 22 along the longitudinal direction of the substrate 12, in which the positive screw thread 26 and counter screw thread 28 respectively engage the arms 221 and 222.

In this way, when manually rotating the threaded rod 24 in one direction, the threaded rod 24 drives the arm 222 to gradually get closer to the arm 221. When manually rotating the threaded rod 24 in the other direction, the threaded rod 24 drives the arm 222 to gradually get away from the arm 221. Since one end of the optical fiber 16 is adhered on the arm 222 at the first affixing point 162 of the substrate 12, the distance between the first and second affixing points 162 and 163 can be manually slightly adjusted. The tension and length of the fiber grids 18 located between the affixing points 162 and 163 can be manually adjusted by rotating the threaded rod 24.

Second Embodiment

FIG. 2 is a top plan view illustrating a second embodiment of an FBG thermal compensating device 10′ according to this invention. The device 10′ comprises: a substrate 12′, means for compressing optical fiber, and an optical fiber 16′. In this embodiment, the compressing means includes a first metal block 14′ and a second metal block 142′ each affixed to the substrate 12′, and the optical fiber 16′ is affixed to the two metal blocks 14′, 142′ along a longitudinal direction thereof, wherein the optical fiber 16′ is embedded with grids 18′ at a mid-section thereof.

As illustrated in FIG. 2, the substrate 12′ is formed with an indent 122′ thereon. The indent 122′ has a first length L1 that is greater than sum of a second and third length L2, L3 of the respective metal blocks 14′, 142′ such that when the two metal blocks 14′, 142′ are affixed into the indent 122′, the substrate 12′ is remained with a space 124′. The fiber grids 18′ further have an overall length LG being slightly smaller than the difference between the first length L1 and the sum of L2, L3.

The substrate 12′ is preferably made of quartz; the metal blocks 14′, 142′ are preferably made of aluminum or stainless steel. In this embodiment, the optical fiber 16′ has an end that is affixed to the first metal block 14′ at a first affixing point 163′, and another end to the second metal block 142′ at a second affixing point 162′ in such a manner that the grids 18′ of the optical fiber 16′ happen to be exposed next to the space 124′.

The fiber grids 18′ are preferably to be affixed to metal blocks by means of instant cured adhesive while the fiber grids 18′ are under tension. The optical fiber 16′ may alternatively be first adhered to the metal blocks 14′, 142′ using AB thermally cured adhesive, and then cured to the metal blocks 14′, 142′ under a thermal state—such as at a temperature of 100° C. The device may further be placed under a thermal date, after the process of thermal curing, for a pre-determined period of time so as to perform annealing to the fiber grids 18′ thereby further simplifying the manufacturing process.

When the device experiences thermal effects, such as increment in environmental temperature, the entire device 10′ will expand. Because the quartz substrate 12′ has a thermal expansion coefficient that is much smaller than the thermal expansion coefficient of the metal blocks 14′, 142′, the expansion effect of the quartz substrate 12′ can, thus, be neglected.

Under such a state, only the metal blocks 14′, 142′, in relation to the entire device 10′, expand towards the space 124′ thereby compressing the fiber grids 18′, and causing reduction of the grid wavelength that was increased as a result of increment in environmental temperature. As such, the central wavelength of the fiber grids 18′ can be prevented from deviation. The affixing points 162′, 163′ of the device 10′ can be determined by referring to the equation discussed in the first embodiment.

FIGS. 4C and 4D illustrate two flowcharts for manufacturing the optical fiber Bragg grating thermal compensating device of FIG. 2. In the devices named in FIGS. 4C and 4D, prior to affixing an end of the optical fiber 16′ to the second metal block 142′ at the affixing point 162, the affixing point 163′ is selected on the metal block 14′ in accordance with the above equation.

Referring to FIG. 2A, the FBG thermal compensating device 10′ of the second embodiment illustrated in FIG. 2 may further include a manually adjusting means 20′ coaxially provided on the substrate 12′ along the longitudinal direction of the substrate 12′. Similar to the embodiment illustrated in FIG. 1A and described hereinbefore, the distance between two arms 221′ and 222′ can be adjusted by rotating the threaded rod 24′, and the distance between the first and second affixing points 162′ and 163′ can be manually slightly adjusted. The tension and length of the fiber grids 18′ located between the affixing points 162′ and 163′ can be manually adjusted by rotating the threaded rod 24′.

Third Embodiment

FIG. 3 is a top plan view illustrating a third embodiment of an FBG thermal compensating device 10″ according to this invention. The device 10″ comprises: a substrate 12″, means for compressing optical fiber, and an optical fiber 16″. In this embodiment, the compressing means includes a first metal block 14″ and a compensating block 19″ each affixed to the substrate 12″, and the optical fiber 16″ is adhered to the compensating block 19″ along a longitudinal surface thereof, wherein the optical fiber 16″ is embedded with grids 18″ at a mid-section thereof.

As illustrated in FIG. 3, the substrate 12″ is formed with an indent 122″ thereon. The indent 122″ has a first length L1 that is greater than a second length L2 of the metal block 14″ such that when the metal block 14″ is affixed into and end of the indent 122″, the substrate 12″ is remained with a space (not numerated) between the substrate 12″ and the metal block 14″ for receiving the compensating block 19″. The grids 18″ further have an overall length LG being slightly smaller than a fourth length L4 of the compensating block 19″.

The substrate 12″ is preferably made of quartz; the metal block 14″ is preferably made of aluminum or stainless steel; the compensating block 19″ is preferably made of pliable material.

The grids 18″ are preferably adhered to the compensating block 19″ along their surfaces by means of instant cured adhesive, such that the grids are located next to the compensating block 19″.

When the device experiences thermal effects, such as increment in environmental temperature, the entire device 10″ will expand. Because the quartz substrate 12″ has a thermal expansion coefficient that is much smaller than the thermal expansion coefficient of the metal block 14″ and the compensating block 19″, 142″, the expansion effect of the quartz substrate 12″ can, thus, be neglected.

Under such a state, only the metal block 14″, in relation to the entire device 10″, expands towards the compensating block 19″ thereby causing the compensating block 19″ to drive axial compression of the fiber grids 18″, and causing reduction of the grid wavelength that was increased as a result of increment in environmental temperature. As such, the central wavelength of the fiber grids 18″ can be prevented from deviation. The relative length of the metal bock and the compensating block can be designated by referring to the equation discussed in the first embodiment. However, in the embodiment, special attention should be given to the Young's modulus of the metal block and the compensating block, where the Young's modulus of the metal block is always greater than that of the compensating block.

FIG. 4E illustrates the flowchart for manufacturing the optical fiber Bragg grating thermal compensating device of FIG. 3.

Referring to FIG. 3A, the FBG thermal compensating device 10″ of the third embodiment illustrated in FIG. 3 may further include a manually adjusting means 20″ coaxially provided on the substrate 12″ along the longitudinal direction of the substrate 12″. In the embodiment illustrated in FIG. 3A, the substrate 12″ is further formed with a second indent 22″ at one end of the substrate 12″, and forming two arms 221″ and 222″ spaced apart along the longitudinal direction of the substrate 12″. A threaded rod 24″ having a section of positive screw thread 26″ and a section of counter screw thread 28″ is disposed across the second indent 22″ along the longitudinal direction of the substrate 12″, in which the positive screw thread 26″ and counter screw thread 28″ are respectively engage the arms 221″ and 222″.

In this way, when manually rotating the threaded rod 24″ in one direction, the threaded rod 24″ drives the arm 222″ to gradually get closer to the arm 221″. When manually rotating the threaded rod 24″ in the other direction, the threaded rod 24″ drives the arm 222″ to gradually get away from the arm 221″. The distance between the metal block 14″ and the second arm 222″ that forms a space for receiving the compensating block 19″ can be manually slightly adjusted. Since the fiber grids 18″ are adhered to the compensating block 19″ along their surfaces, and the compensating block 19″ is disposed between the metal block 14″ and the second arm 222″, the tension and length of the fiber grids 18″ can be manually adjusted by rotating the threaded rod 24″.

Fourth Embodiment

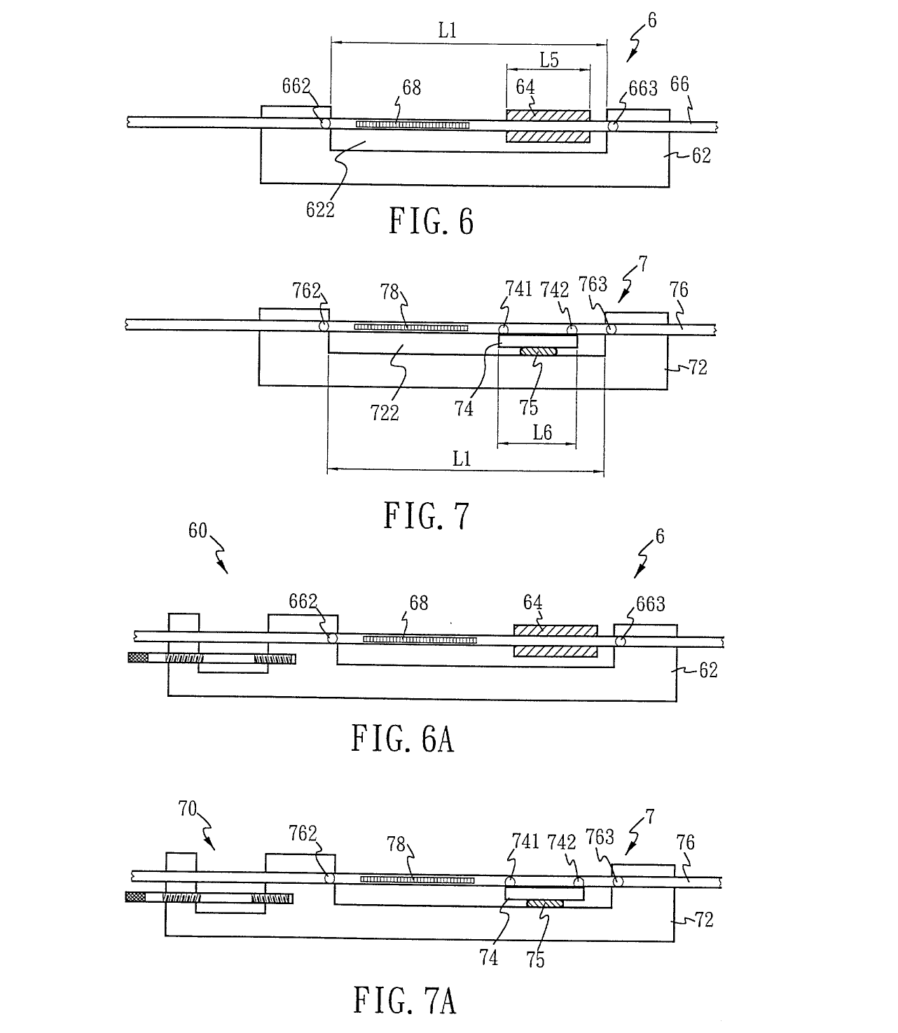

FIG. 6 is a top plan view illustrating a fourth embodiment of an FBG thermal compensating device 6 according to this invention. The device 6 comprises: a substrate 62, means for compressing optical fiber, and an optical fiber 66. In this embodiment, the compressing means includes a layer of thin film 64 having a thermal expansion coefficient greater than a thermal expansion coefficient of the substrate 62 and integrally surrounding and firmly coating on a section of the optical fiber 66, and the optical fiber 66 is affixed to the substrate 62 along a longitudinal direction thereof, wherein the optical fiber 66 is embedded with grids 68 at a mid-section thereof.

As illustrated in FIG. 6, the substrate 62 is formed with a first indent 622 thereon. The first indent 622 has a first length L1 that is greater than a fifth length L5 of the thin film 64 such that the thin film 64 is allowed to expand along the longitudinal direction of the optical fiber 66 within the first indent 622.

The substrate 62 is preferably made of quartz; the thin film 64 is preferably made of metal such as aluminum or copper , or mixture of metallic powder and epoxy resin. In this embodiment, the optical fiber 66 has two ends respectively affixed to the substrate 62 at a first affixing point 662 and at a second affixing point 663 in such a manner that the grids 68 of the optical fiber 66 and the thin film 64 are located between the two affixing points 662 and 663.

The fiber grids 68 are preferably to be affixed to the substrate by means of instant cured adhesive while the fiber grids 68 are under tension.

When the device experiences thermal effects, such as increment in environmental temperature, the entire device 6 will expand. Because the thermal expansion coefficient of the quartz substrate 62 is much smaller than the thermal expansion coefficient of the thin film 64, the expansion effect of the quartz substrate 62 can, thus, be neglected.

Because the grids 68 and the thin film 64 are located between two affixing points 662 and 663, and the thermal expansion coefficient of the thin film 64 is greater than the thermal expansion coefficient of the substrate 62, only the thin film 64, in relation to the entire device 6, expands towards the fiber grids 68 thereby compressing the fiber grids 68 against the affixing point 662, and causing reduction of the grid wavelength that was increased as a result of increment in environmental temperature. As such, the central wavelength of the fiber grids 68 can be prevented from deviation.

The length L5 of the thin film 64 can be designated by referring to the equation discussed in the first embodiment.

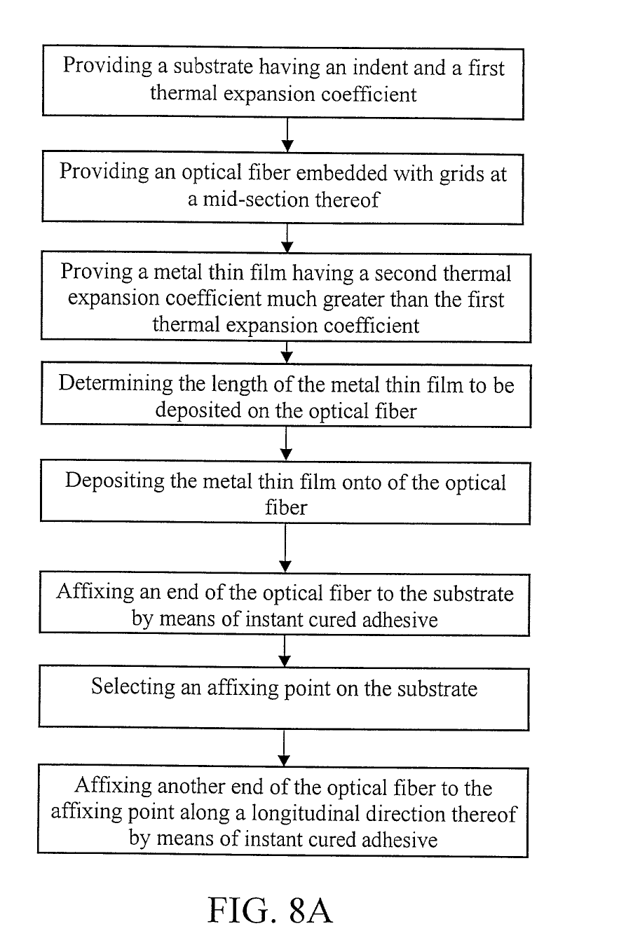

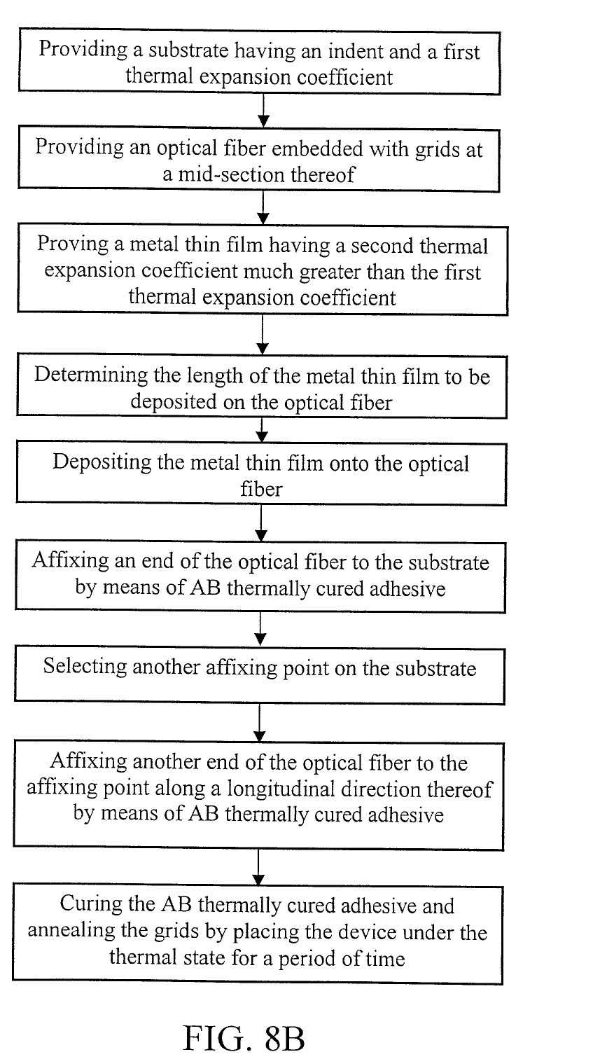

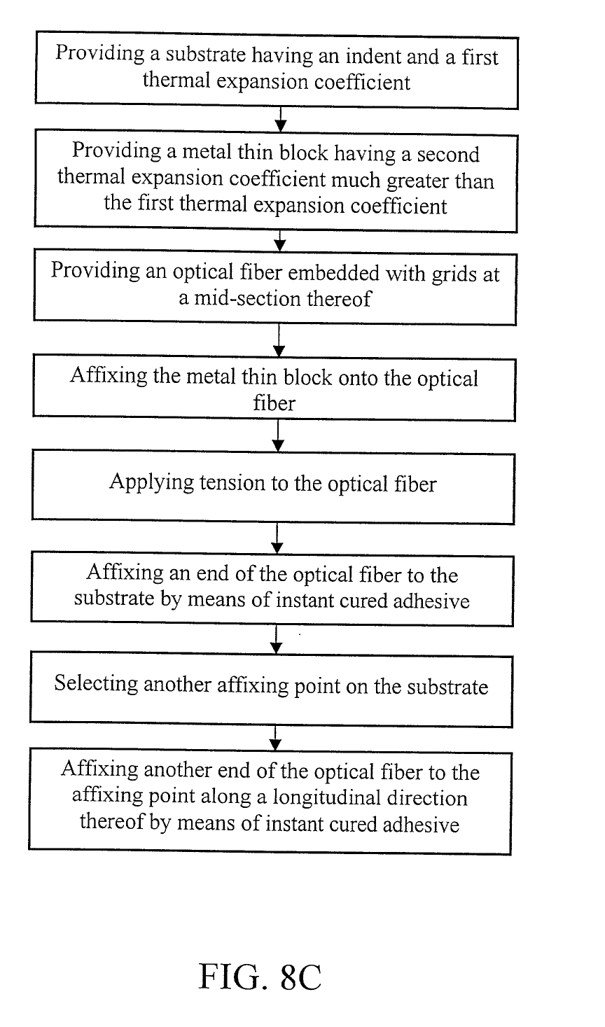

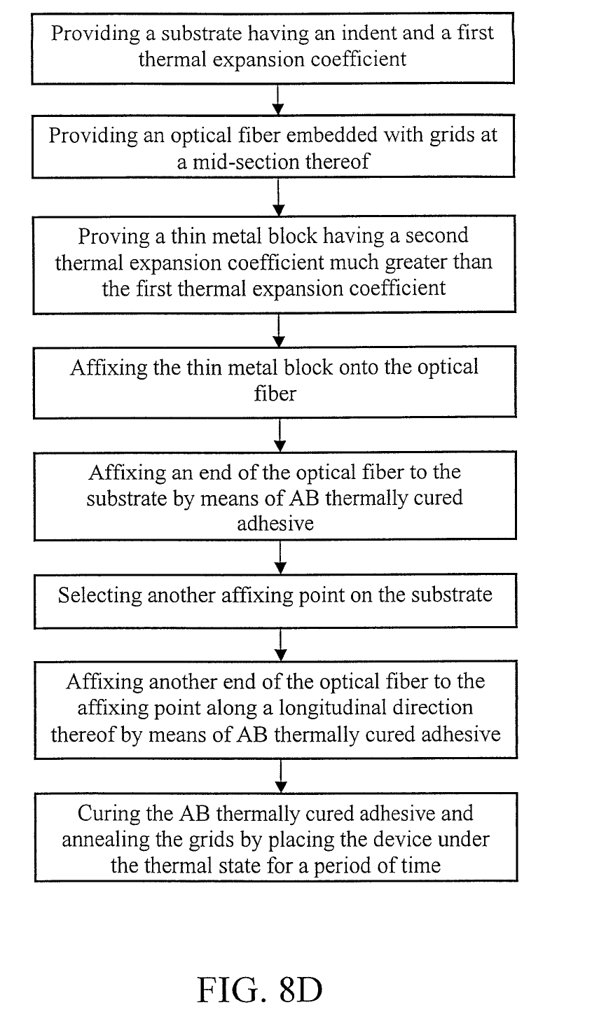

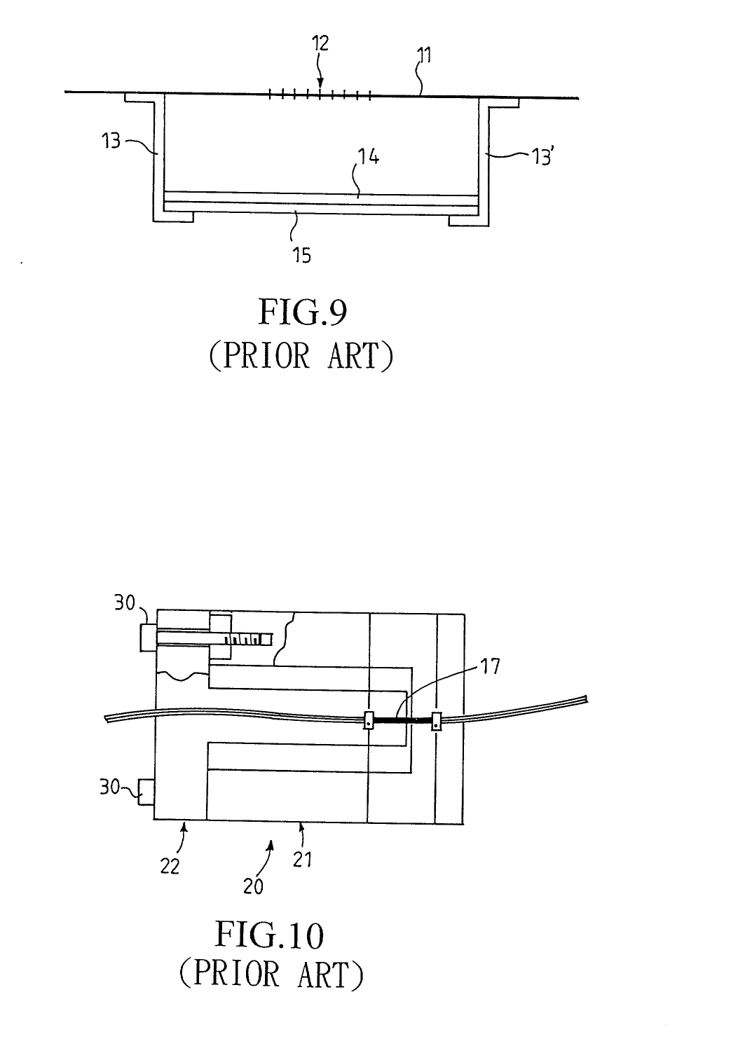

FIGS. 8A and 8B illustrate two flowcharts for manufacturing the optical fiber Bragg grating thermal compensating device of FIG. 6. In the devices named in FIGS. 8A and 8B, prior to affixing an end of the optical fiber 66 to the substrate 62 at the affixing point 662, the affixing point 663 and the longitudinal length L5 of the thin film 64 are determined in accordance with the above equation.

Referring to FIG. 6A, the FBG thermal compensating device 6 of the fourth embodiment illustrated in FIG. 6 may further include a manually adjusting means 60, similar to the manually adjusting means 20, 20′ and 20″ illustrated in FIGS. 1A, 2A and 3A, coaxially provided on the substrate 62 along the longitudinal direction of the substrate 62, so as to manually adjust an axial tension of the optical fiber 66 located between two affixing points 662 and 663 along the longitudinal direction of the substrate 62,

Fifth Embodiment

FIG. 7 is a top plan view illustrating a fifth embodiment of an FBG thermal compensating device 7 according to this invention. The device 7 comprises: a substrate 72, means for compressing optical fiber, and an optical fiber 76. In this embodiment, the compressing means includes a floating metal block 74 affixed to the optical fiber 76 at two affixing points 741 and 742 along a longitudinal direction of the optical fiber 76 and having a thermal expansion coefficient greater than a thermal expansion coefficient of the substrate 72, and the optical fiber 76 is affixed to the substrate 72 along the longitudinal direction thereof, wherein the optical fiber 76 is embedded with grids 78 at a mid-section thereof.

As illustrated in FIG. 7, the substrate 72 is formed with a first indent 722 thereon. The first indent 722 has a first length L1 that is greater than a sixth length L6 of the floating metal block 74 such that the floating metal block 74 is allowed to expand along the longitudinal direction of the optical fiber 76 within the first indent 722.

The substrate 72 is preferably made of quartz; the floating metal block 74 is preferably made of aluminum or stainless steel. In this embodiment, the optical fiber 76 has two ends respectively affixed to the substrate 72 at a first affixing point 762 and at a second affixing point 763 in such a manner that the fiber grids 78 of the optical fiber 76 and the floating metal block 74 are located between two affixing points 762 and 763.

The fiber grids 78 are preferably to be affixed to the substrate 72 and/or floating metal block 74 by means of instant cured adhesive while the fiber grids 68 are under tension.

When the device 7 experiences thermal effects, such as increment in environmental temperature, the entire device 7 will expand. Because the thermal expansion coefficient of the quartz substrate 72 is much smaller than the thermal expansion coefficient of the floating metal block 74, the expansion effect of the quartz substrate 72 can, thus, be neglected.

Because the fiber grids 78 and the floating metal block 74 are located between two affixing points 762 and 763, and the thermal expansion coefficient of the floating metal block 74 is much greater than the thermal expansion coefficient of the optical fiber 76, only the floating metal block 74, in relation to the entire device 7, expands towards the fiber grids 78 thereby compressing the fiber grids 78 against the affixing point 762, and causing reduction of the grid wavelength that was increased as a result of increment in environmental temperature. As such, the central wavelength of the fiber grids 78 can be prevented from deviation.

The distance between the affixing points 741 and 742 and the length L6 of the floating metal block 74 can be designated by referring to the equation discussed in the first embodiment.

Preferably, the floating metal block 74 is adhered to the substrate 72 by elastically deformable adhesive 75, such as rubber or soft gel, so that the floating metal block 74 is freely expandable along the longitudinal direction of the optical fiber 76.

FIGS. 8C and 8D illustrate two flowcharts for manufacturing the optical fiber Bragg grating thermal compensating device of FIG. 7. In the devices named in FIGS. 8C and 8D, prior to affixing an end of the optical fiber 76 to the substrate 72 at the affixing point 762, the affixing point 763 and the longitudinal length L6 of the thin metal block 74 are determined in accordance with the above equation.

Referring to FIG. 7A, the FBG thermal compensating device 7 of the fifth embodiment illustrated in FIG. 7 may further include a manually adjusting means 70, similar to the manually adjusting means 20, 20′, 20″ and 60 illustrated in FIGS. 1A, 2A, 3A and 6A, coaxially provided on the substrate 72 along the longitudinal direction of the substrate 72, so as to manually adjust an axial tension of the optical fiber 76 located between two affixing points 762 and 763 along the longitudinal direction of the substrate 72, As compared with the conventional FBG thermal compensating devices having a bi-metal construction, the thermal compensating devices according to this invention consist the advantages of simple constructions and simplified manufacturing processes. Based on the first embodiment of this invention, determination of the length of the metal block allows heat can be conducted to the metal block in an expeditious manner so as to allow immediate response of the metal block to the thermal expansion of the fiber grids. Based on the second embodiment of this invention, the device allows rapid positioning and manufacturing. Based on the first and second embodiments of this invention, when the fiber grids are cured to the device using AB thermally cured adhesive under a thermal state, the need for applying a pre-load is eliminated; the device can also be placed under a thermal state, after the process of thermal curing, for a pre-determined period of time so as to perform annealing to the fiber grids thereby further simplifying the manufacturing process. Based on the third embodiment of this invention, the fiber grids are secured to the device under a load-free, and room temperature state, thereby eliminates the need of applying a pre-load.

Based on the fourth or fifth embodiment of this invention, since the metal thin film 64 or floating metal block 74 can be secured to anywhere on the optical fiber 66 or 76 located between the first affixing point 662 and second affixing point 663 on the substrate 62, the design, manufacture and assembling the device can be further simplified.

Aforementioned explanation is directed to the description of the preferred embodiment according to the present invention. Various changes and implementations can be made by personals skilled in the art without departing from the technical concept of the present invention. Since the present invention is not limited to the specific details described in connection with the preferred embodiment except those that may be within the scope of the appended claims, changes to certain features of the preferred embodiment without altering the overall basic function of the invention are contemplated.

What is claimed is:

1. An optical fiber Bragg grating thermal compensating device, comprising:
a substrate, formed with an indent having a first length thereon and having a first thermal expansion coefficient;
means for compressing optical fibers; and
an optical fiber embedded with grids, the grids being affixed to the compressing means.

2. The device according to claim 1, wherein the compressing means includes a first metal block having a second thermal expansion coefficient that is much greater than the first thermal expansion coefficient, and a second length smaller than the first length, the first metal block being affixed to an end of the indent of the substrate such that a space is formed between the substrate and the metal block; and
wherein the optical fiber have a first end affixed to the first metal block and a second end affixed to a affixing member of the substrate, the affixing member being located in the indent of the substrate and distant from the first metal block.

3. The device according to claim 1, wherein the compressing means includes:
a first metal block having a second thermal expansion coefficient that is much greater than the first thermal expansion coefficient, and a second length smaller than the first length, the first metal block being affixed to an end of the indent of the substrate such that a space is formed between the substrate and the metal block;
a compensating block, made of a pliable material of a lower rigidity than that of the metal block and the substrate, and having a fourth length adapted to be affixed within the space; and
wherein the grids have an overall length being slightly smaller than the fourth length, and are adhered to the compensating block along their surface such that the grids are located next to the compensating block.

4. The device according to claim 1, wherein the compressing means includes a thin film having a second thermal expansion coefficient that is much greater than the first thermal expansion coefficient, and a fifth length smaller than the first length, the thin film being integrally surrounding and firmly coating on the optical fiber located within the indent of the substrate such that the thin film is allowed to expand within the indent along a longitudinal direction of the optical fiber; and
wherein the optical fiber has two ends respectively affixed to the substrate at a first affixing point and at a second affixing point along the longitudinal direction of the optical fiber, so that the fiber grids and the thin film are located between the first and the second affixing points and located within the indent of the substrate.

5. The device according to claim 5, wherein the thin film of the compressing means is made of metal, such as aluminum or copper, integrally coated on the optical fiber.

6. The device according to claim 6, wherein the thin film of the compressing means is made of mixture of metallic powder and epoxy resin integrally formed on the optical fiber.

7. The device according to claim 1, wherein the compressing means includes a floating metal block having a second thermal expansion coefficient that is much greater than the first thermal expansion coefficient, and a sixth length smaller than the first length, the floating metal block being affixed to the optical fiber along a longitudinal direction of the optical fiber located within the indent of the substrate such that the floating metal block is allowed to expand within the indent along the longitudinal direction of the optical fiber; and
wherein the optical fiber has two ends respectively affixed to the substrate at a first affixing point and at a second affixing point along the longitudinal direction of the optical fiber, so that the fiber grids and the floating metal block are located between the first and the second affixing points and located within the indent of the substrates.8. The device according to claim 7, wherein the floating metal block is adhered to the substrate by a elastically deformable adhesive that allows the floating metal block to expand along the longitudinal direction of the optical fiber within the indent.

9. The device according to claim 1, further comprising a manually adjusting means including: a first and a second arms integrally formed at one end of the substrate and spaced apart with each other along a longitudinal direction of the substrate, and a threaded rod having a section of positive screw thread and a section of counter screw thread, in which the sections of the positive screw thread and the counter screw thread respectively engage the first and second arms, so that the first and second arms can move relatively along the longitudinal direction of the substrate, when rotating the threaded rod.

10. An optical fiber Bragg grating thermal compensating device, comprising:
a substrate, formed with an indent having a first length thereon and having a first thermal expansion coefficient;
a first metal block having a second thermal expansion coefficient that is much greater than the first thermal expansion coefficient, and a second length smaller than the first length, the first metal block being affixed to an end of the indent of the substrate such that a space is formed between the substrate and the metal block; and
an optical fiber embedded with grids, the grids having a first end affixed to the first metal block and a second end affixed to a affixing member of the substrate, the affixing member being located in the indent of the substrate and distant from the first metal block.

11. The device according to claim 10, wherein the first metal block is in contact with part of the grids next to the first metal block.

12. The device according to claim 10, wherein the affixing member is an integral part of the substrate.

13. The device according to claim 10, further comprising a manually adjusting mean including: a first and a second arms integrally formed at one end of the substrate and spaced apart with each other along a longitudinal direction of the substrate, and a threaded rod having a section of positive screw thread and a section of counter screw thread, in which the sections of the positive screw thread and the counter screw thread respectively engage the first and second arms, so that the first and second arms can move relatively along the longitudinal direction of the substrate, when rotating the threaded rod.

14. The device according to claim 10, wherein the affixing member is a second metal block having the second thermal expansion coefficient and a third length, and wherein sum of the second and third length is smaller than the first length such that a space is remained between the two metal blocks when the first and the second metal blocks are each affixed to opposing ends of the indent.

15. The device according to claim 14, wherein the grids have an overall length being slightly smaller than the difference between the first length and the sum of the second and third length.

16. The device according to claim 10, wherein the optical fiber is cured to the substrate and/or the metal block by AB thermally cured adhesive at a temperature of 100° C.

17. The device according to claim 10, where in the grids are affixed to the substrate and/or metal block by means of instant cured adhesive while the grids are under tension.

18. The device according to claim 10, wherein the substrate is made of quartz.

19. The device according to claim 10, wherein the metal block is made of aluminum.

20. The device according to claim 10, wherein the metal block is made of stainless steel.

21. An optical fiber Bragg grating thermal compensating device, comprising:
a substrate, formed with an indent having a first length thereon and having a first thermal expansion coefficient;
a first metal block having a second thermal expansion coefficient that is much greater than the first thermal expansion coefficient, and a second length smaller than the first length, the first metal block being affixed to an end of the indent of the substrate such that a space is formed between the substrate and the metal block;
a compensating block, made of a pliable material of a lower rigidity than that of the metal block and the substrate, and having a fourth length adapted to be affixed within the space; and
an optical fiber embedded with grids, the grids having an overall length being slightly smaller than the fourth length, and being adhered to the compensating block along their surfaces such that the grids are located next to the compensating block.

22. The device according to claim 21, wherein the substrate is made of quartz.

23. The device according to claim 21, wherein the metal block is made of aluminum.

24. The device according to claim 21, wherein the metal block is made of stainless steel.

25. The device according to claim 21, further comprising a manually adjusting means including: a first and a second arms integrally formed at one end of the substrate and spaced apart with each other along a longitudinal direction of the substrate, and a threaded rod having a section of positive screw thread and a section of counter screw thread, in which the sections of the positive screw thread and the counter screw thread respectively engage the first and second arms, so that the first and second arms can move relatively along the longitudinal direction of the substrate, when rotating the threaded rod.

26. A method for manufacturing an optical fiber Bragg grating thermal compensating device, comprising the steps of:
(a) providing a substrate having a first thermal expansion coefficient, and formed with an indent having a first length;
(b) providing a first metal block having a second thermal expansion coefficient much greater than that first thermal expansion coefficient, and a second length smaller than the first length;
(c) affixing the first metal block to an end of the indent of the substrate;
(d) providing an optical fiber embedded with grids at a mid-section thereof;
(e) affixing an end of the optical fiber to the first metal block;
(f) selecting an affixing point on the device; and
(g) affixing another end of the optical fiber to the affixing point along a longitudinal direction thereof.

27. The method according to claim 26, wherein the affixing point is located on the substrate distant from the first metal block.

28. The method according to claim 26, further comprising the following steps prior to step (d):
(c-1) providing a second metal block having the second thermal expansion coefficient, and a third length smaller than the difference between the first and the second length; and
(c-2) affixing the second metal block to another end of the indent of the substrate such that a space is formed between the first and the second metal blocks.

29. The method according to claim 28, wherein the affixing point is located on the second metal block.

30. The method according to claim 26, further comprising the step of:
(h) placing the device under a thermal state.

31. The method according to claim 30, wherein the optical fiber is cured to the substrate and the metal block by AB thermally cured adhesive.

32. The method according to claim 31, further comprising the following step of:
(i) annealing the grids by continuously placing the device under the thermal state for a pre-determined period of time.

33. The method according to claim 26, further comprising the following step prior to step (e):
(d-1) applying tension to the optical fiber.

34. The method according to claim 26, wherein the substrate is made of quartz.

35. The method according to claim 26, wherein the metal block is made of aluminum.

36. The method according to claim 26, wherein the metal block is made of stainless steel.

37. A method for manufacturing an optical fiber Bragg grating thermal compensating device, comprising the steps of:
(a) providing a substrate having a first thermal expansion coefficient, and formed with an indent having a first length;
(b) providing a first metal block having a second thermal expansion coefficient much greater than that first thermal expansion coefficient, and a second length smaller than the first length;
(c) affixing the first metal block to an end of the indent of the substrate;
(d) providing a compensating block made of a pliable material of a lower rigidity than that of the metal block and the substrate;
(e) affixing the compensating block within the space;
(f) providing an optical fiber embedded with grids at a mid-section thereof; and
(g) affixing the optical fiber to compensating block along a longitudinal surface thereof such that the grids are located next to the compensating block.

38. The method according to claim 37, wherein the substrate is made of quartz.

39. The method according to claim 37, wherein the metal block is made of aluminum.

40. The method according to claim 37, wherein the metal block is made of stainless steel.

41. An optical fiber Bragg grating thermal compensating device, comprising:
a substrate, formed with an indent having a first length thereon and having a first thermal expansion coefficient;
an optical fiber embedded with grids, having two ends respectively affixed to the substrate at a first affixing point and at a second affixing point along a longitudinal direction of the optical fiber;
a thin film having a second thermal expansion coefficient that is much greater than the first thermal expansion coefficient, and a fifth length smaller than the first length, the thin film being integrally surrounding and firmly coating on the optical fiber located within the indent of the substrate such that the grids and the thin film are located between the first and the second affixing points, and the thin film is allowed to expand within the indent along the longitudinal direction of the optical fiber.

42. The device according to claim 41, wherein the thin film is made of metal or mixture of metal powder and epoxy resin.

43. The device according to claim 41, further comprising a manually adjusting mean including: a first and a second arms integrally formed at one end of the substrate and spaced apart with each other along a longitudinal direction of the substrate, and a threaded rod having a section of positive screw thread and a section of counter screw thread, in which the sections of the positive screw thread and the counter screw thread respectively engage the first and second arms, so that the first and second arms can move relatively along the longitudinal direction of the substrate, when rotating the threaded rod.

44. An optical fiber Bragg grating thermal compensating device, comprising:
a substrate, formed with an indent having a first length thereon and having a first thermal expansion coefficient;
an optical fiber embedded with grids, having two ends respectively affixed to the substrate at a first affixing point and at a second affixing point along a longitudinal direction of the optical fiber;
a floating metal block having a second thermal expansion coefficient that is much greater than the first thermal expansion coefficient, and a sixth length smaller than the first length, the floating metal being integrally surrounding and firmly coating on the optical fiber located within the indent of the substrate such that the grids and the floating metal block are located between the first and the second affixing points, and the floating metal block is allowed to expand within the indent along the longitudinal direction of the optical fiber.

45. The device according to claim 44, wherein the floating metal block is adhered to the substrate by an elastically deformable adhesive that allows the floating metal block to expand within the indent along the longitudinal direction of the optical fiber.

46. The device according to claim 44, further comprising a manually adjusting mean including: a first and a second arms integrally formed at one end of the substrate and spaced apart with each other along a longitudinal direction of the substrate, and a threaded rod having a section of positive screw thread and a section of counter screw thread, in which the sections of the positive screw thread and the counter screw thread respectively engage the first and second arms, so that the first and second arms can move relatively along the longitudinal direction of the substrate, when rotating the threaded rod.
